(19) United States
(12) Patent Application Publication
(10) Pub. No.: US 2010/0180425 A1
(43) Pub. Date: Jul. 22, 2010

(54) Trophy system with spinner assembly

(75) Inventor: Barbara A. Brown, Wellington, CO (US)

Correspondence Address: CR MILES, P.C.;CRAIG R. MILES, 405 MASON COURT, SUITE 119, FORT COLLINS, CO, 80524, US

(73) Assignee: Simply Awards LLC

(21) Appl. No.: 12/590,403

(22) Filed: Nov. 6, 2009

Related U.S. Application Data
(60) Provisional application No. 61/199,121, filed on Nov. 13, 2008.

(51) Int. Cl. B23P 11/00

(52) U.S. Cl. 29/525.11

(57) ABSTRACT

A trophy having a spinner assembly which allows a figurine to rotate in relation to the trophy column or the trophy base or both.

This United States Non-provisional Patent Application claims the benefit of U.S. Provisional Patent Application No. 61/199,121, filed Nov. 13, 2008, hereby incorporated by reference herein.

### BACKGROUND

Generally, a trophy having a spinner assembly which allows a figurine to rotate in relation to the trophy column or the trophy base or both. Specifically, various embodiments of a spinner assembly which mount between the base and the column or between the column and the figurine of a trophy which allows the figurine to rotate in relation to the trophy column or the trophy base or both.

Conventional trophies typically include a base, a column and a figurine which are engaged in fixed relation to each other. These trophy elements are typically axially slidably engaged about the longitudinal axis of a mechanical fastener which operates to draw the trophy elements into fixed engagement with one another.

A substantial problem with conventional trophies can be that the trophy elements are fixedly engaged and do not rotate in relation to each other. As a result, the viewer must travel about the longitudinal axis of the trophy to observe the sides and back of the figurine and column portions or the viewer must forcibly urge the entire trophy to rotate about the longitudinal axis.

The invention described herein addresses the problem of conventional fixed engagement of trophy elements.

### SUMMARY OF THE INVENTION

Accordingly, a broad object of particular embodiments of the invention can be to provide a trophy which provides a figurine which rotates in relation to a column fixed to a base.

Another broad object of particular embodiments of the invention can be to provide a trophy which provides a figurine having fixed relation to a column which rotates in relation to a base.

Another broad object of particular embodiments of the invention can be to provide a trophy which provides a figurine which rotates in relation to a column and a column which rotates in relation to a base.

Another broad object of the invention can be to provide a spinner assembly which can be engaged between the figurine and the column of a trophy, or can be engaged between the column and the base of a trophy which allows the figurine to rotate in relation to a column, or which allows a column to rotate in relation to a base.

Naturally, further objects of the invention are disclosed throughout other areas of the specification, drawings, photographs, and claims.

### A BRIEF DESCRIPTION OF THE DRAWINGS

FIG. 1 is perspective view of a particular embodiment of a trophy with a spinner assembly.

FIG. 2 is an exploded view of a particular embodiment of a trophy with a spinner assembly coupled between a figurine and a column.

FIG. 3 is a cross-section view of the particular embodiment of a trophy with a spinner assembly coupled between figurine and a column of FIG. 2.

FIG. 4 is an exploded view of a particular embodiment of a trophy with a spinner assembly coupled between a column and a base.

FIG. 5 is a cross-section view of the particular embodiment of a trophy with a spinner assembly coupled between a column and a base as shown in FIG. 4.

### DETAILED DESCRIPTION OF THE PREFERRED EMBODIMENTS

Generally, a trophy having a spinner assembly which allows a figurine to rotate in relation to the trophy column or the trophy base or both. Specifically, various embodiments of a spinner assembly which mount between the base and the column or between the column and the figurine of a trophy which allows the figurine to rotate in relation to the trophy column or the trophy base or both.

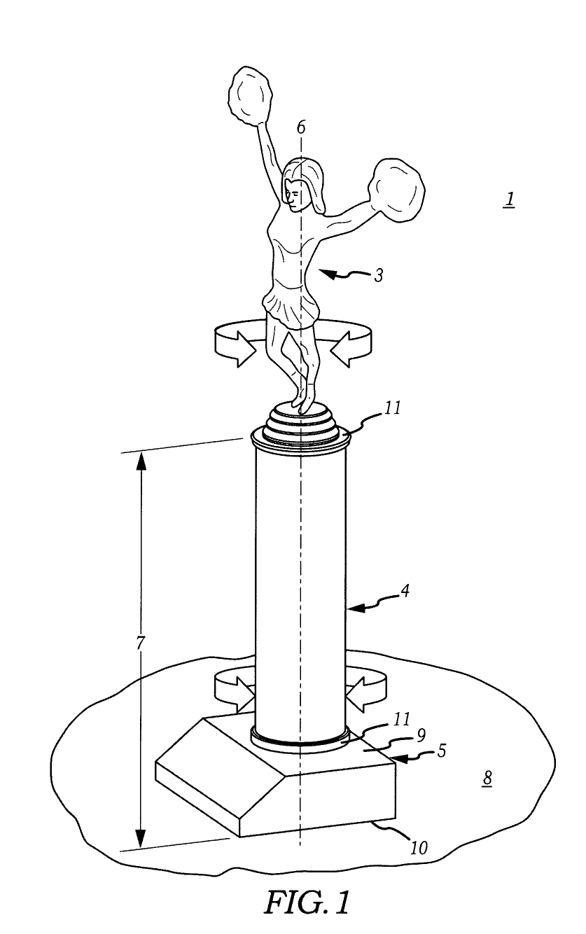

Now primarily referring to FIG. 1, which illustrates a method of using a trophy (1) which includes a spinner assembly (2), as further described below. A trophy (1) generally includes a figurine (3), a column (4), and a base (5).

For the purposes of this invention, the term “figurine” means an object which can have any of a numerous and wide variety of external configurations capable of coupling to the column whether directly or indirectly by use of the spinner assembly (2) and while the figurine shown in FIG. 1 has the configuration of a cheerleader, the figure could be configured as a person of any trade or profession for example without limitation a sales person, an athlete, a motor vehicle driver, a graduate, or the like, or an animal for example without limitation a show animal, a meat animal, work animal, a horse, a cow, a pig, a dog, a cat, a bird, or the like, or a motor vehicle for example without limitation a passenger car, a motor home, a race car, a truck, or the like, or a plaque with an inscription, or other configuration(s).

For the purposes of this invention, the term “column” means a vertical member having a configuration which couples whether directly or indirectly by use of the spinner assembly (2) between the figurine (3) and the base (5) to support the figurine (3) and while the column (4) shown in FIG. 1 has an elongate cylindrical configuration which supports the figurine (3) at an elevation (7) above the base (5), the invention is not so limited, and the column (4) can have a numerous and wide variety of configurations which in cross-section perpendicular to the longitudinal axis (6) of the column (4) can without limitation include a cylinder, a square, a rectangular, a triangular, an oval, or the like, or such cross-section can define an irregular symmetry about the longitudinal axis (6), or other symmetry, which can be coupled by an embodiment of the spinner assembly (2) to either of the figurine (3) or the base (5), or both and while the column (4) can have a height substantially greater than the height of the base (5) to locate the figurine (3) at a particular elevation (7) above a support surface (8), the column is not so limited and the column can be any height which allows use of the spinner assembly (2) between the column (4) and the figurine (3) or between the column (4) and the base (5), or both.

For the purposes of this invention, the term “base” means a constructional form having a first base end (9) which couples directly, or indirectly by the spinner assembly (2), to the column and a second base end (10) which engages the support surface (8), the second base end (10) having sufficient area of engagement to establish and maintain the trophy (1) in a substantially vertical condition as shown by the example of FIG. 1 during normal use.

Accordingly, the example of the trophy (1) shown in FIG. 1 is not meant to be limiting but rather illustrative of the numerous and varied embodiments of the trophy (1) which can be achieved based upon the various permutations and combinations of particular figurines (3), columns (4) and bases (5), which can be used with the spinner assembly (2).

Embodiments of the spinner assembly (2) allow the figurine (3) to rotate about the longitudinal axis (6) of the trophy (1). As to certain embodiments of the trophy (1) which include the spinner assembly (2), forcible urging of the figurine (3) can result in rotation about the longitudinal axis (6) of the trophy (1) while the column remains in fixed relation to the base (5). As to other embodiments of the trophy (1) which include the spinner assembly (2), forcible urging of the column (4) can result in rotation of the column (4) about the longitudinal axis (6) of the trophy in relation to the base (5). The figurine (3) if in fixed engagement with the column (4) rotates about the longitudinal axis (6) of the trophy (1) with the same frequency as the column (4). As to other embodiments of the trophy (1) which include the spinner assembly (2), forcible urging of the figurine (3) and forcible urging of the column (4) can result in independent rotation of the figurine (3) and independent rotation of the column (4) about the longitudinal axis (6) of the trophy (1). The rotation of the figurine (3) or the column (4), or both, can be clockwise or counter clockwise in direction about the longitudinal axis (6) of the trophy (1). Typically, the base (5) remains in fixed relation to the support surface (8) during the period in which the figurine (3) or the column (4), or both, rotate about the longitudinal axis (6) of the trophy (1).

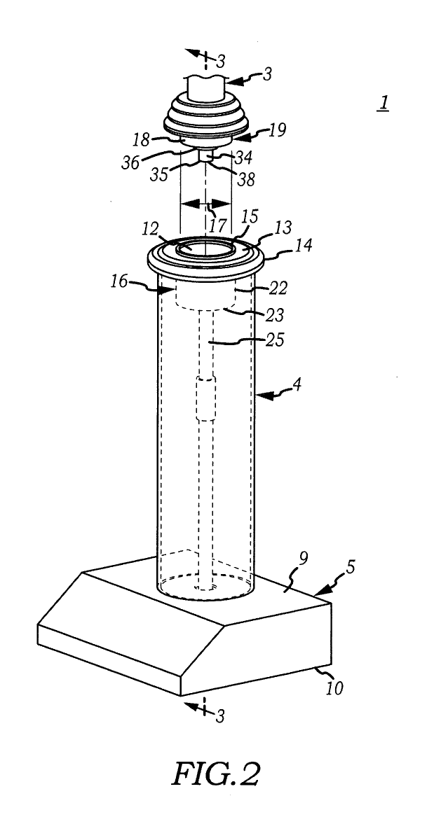

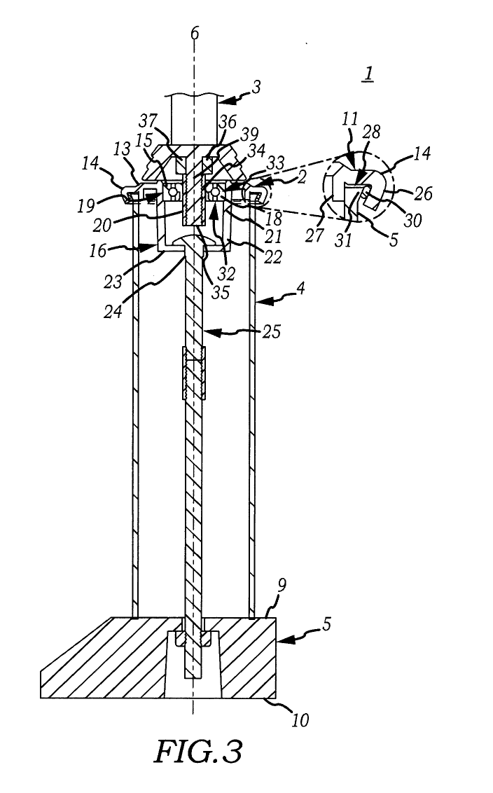

Now referring to primarily to FIGS. 2 and 3, a particular embodiment of a trophy (1) includes a spinner assembly (2) coupled between the figurine (3) and the column (4) allowing the figurine (3) to rotate about the longitudinal axis (6) of the trophy (1). As one example, the embodiment of the spinner assembly (2) shown in FIG. 2 includes a column cover (11). The column cover (11) can have an annular aperture (12). An annular member (13) can extend radially outward between an inner periphery (15) defined by the annular aperture (12) and an outer periphery (14). The outer periphery (14) of the column cover (11) can have a substantially circular configuration dimensionally configured in a manner similar to the cross-sectional circular configuration of the column (4).

Now referring specifically to FIG. 3, the column cover (11) can further include an outer ring (26) and an inner ring (27) coaxially coupled proximate the outer periphery (14) to provide a circular channel (28) in which the first circular end of the column (4) can insert. As to certain embodiments, an amount of an adhesive (30) can be applied in the circular channel (28) to allow fixed engagement of the circular end of the column (4) in the circular channel (28). Alternately, as to other embodiments, the outer ring (26) or the inner ring (27) or both can further be configured to provide a column securement element (29). Matable parts of the column securement element (29) and the column (4) can allow fixed engagement of the column cover (11) with the column (4). The column securement element (29) can be configured to provide compression fit of part of the inner ring (27) or the outer ring (26) with a corresponding part of the internal surface or external surface of the column (4), and as to other embodiments, the column securement element (29) can include proximate the column end which engages the circular channel (28) a radially outwardly projecting lip (31). The outer ring (26) can have sufficient resilient flexure to travel outwardly over the lip (31) and return inwardly to fixingly engage a part of the surface of the outer ring (26) with a part of the surface of the lip (31). Additionally, certain embodiments secure the column cover (11) to the column (4) in fixed engagement by the alternate means described below or in combination with the column securement element(s) (29) as above-described.

Now referring primarily to FIG. 3, the inner periphery (15) of the annular aperture (12) of the column cover (11) can couple to a cylindrical bearing cup (16). The internal diameter (17) of the cylindrical bearing cup (16) can engage the external surface of an outer race (18) of a roller element bearing (19) to radially locate a roller bearing aperture (20) at a location substantially coaxial to the annular aperture (12) of the annular member (13) and the longitudinal axis (6) of the trophy (1). The internal surface of the cylindrical walls (22) of the cylindrical bearing cup (16) can step radially inward to provide an annular step (21) which engages the external surface of the outer race (18) of a roller element bearing (19) to allow the roller element bearing (19) to axially locate at a depth in the cylindrical bearing cup (16). As shown in FIG. 3, a first side (32) of the roller element bearing (19) can engage the annular step (21) to locate the second side (33) of the roller element bearing (19) substantially flush with the surface of the column cover (11). A suitable roller element bearing (19) for use in the embodiment of the spinner assembly (2) shown in the example of FIGS. 2 and 3 can be a steel ball bearing plain having an opening for a five-sixteenths inch shaft with an outer diameter of seven-eighths of an inch with a one-quarter inch width available from McMaster-Carr Supply Company, PN 6383K 15. The cylindrical walls (22) of the bearing cup (16) can further extend axially to terminate in a closed end (23). The closed end (23) of the bearing cup can be further perforated to provide a bearing cup (16) securement aperture (24). A securement element (25) such as the mechanical fastener as shown in FIG. 3 can pass through the column cover (11) and through the bearing cup (16) securement aperture (24) and through a corresponding base securement aperture (26) of the base (5). Operation of the securement element (25) draws the column cover (11) and the base (5) into engagement with opposed ends of the column (4). As shown in FIG. 3, the securement element (25) can be a mechanical faster having a body with a head and spiral threads coupled to opposed ends with a radial fastener element having a spiral thread which rotatably engages the spiral thread of the body.

Again referring primarily to FIGS. 2 and 3, the spinner assembly (2) can further provide a spinner shaft (34). A first spinner shaft end (35) axially slidably inserts into the roller bearing aperture (20). A shaft cap (36) extends a distance radially outward proximate the second spinner shaft end (37). The shaft cap (36) engages the second side (33) of the roller element bearing (19). The inserted spinner shaft (32) coupled to the roller element bearing (19) can rotate clockwise or counterclockwise upon sufficient forcible urging. The embodiment of the spinner shaft (34) shown in FIG. 3 further provides a hollow passage (38) capable of fixedly or removably receiving or coupling to an axial extending projection (39) coupled to the figurine (3). As to certain embodiments, the axial extending projection (39) can axially slidably insert into or remove from the hollow passage (38). As to other embodiments, matable spiral threads can be coupled to the hollow passage (38) and the axial extending projection (39) to allow treaded engagement of the hollow passage (38) with the axial extending projection (39) of the figurine (3). By coupling the axial extending projection (39) to the hollow passage (38) of the spinner shaft (34), the spinner shaft (34) and the figurine (3) can rotate either clockwise or counter clockwise upon sufficient forcible urging.

The above description provides one illustrative example of an embodiment of the trophy (1) with a spinner assembly (2) coupled between the FIG. 3) and the column (4). However, this example is not intended to be limiting but rather illustrative of a numerous and wide variety of embodiments of the spinner assembly (2) which can be coupled between the figurine (3) and the column (4). In that regard, it can be understood that the bearing cup (16) can have numerous configurations capable of receiving a corresponding numerous variety of bearings including plain bearings without roller elements, roller element bearing, jewel bearing, fluid bearing, magnetic bearings, flexure bearings, radial bearings, or the like. The inner periphery (15) of the column cover (11) can be correspondingly adjusted in configuration to couple and locate the bearing cup (16) and the bearing (19) at a location to receive the axial extending projection (39) of the figurine (3). The outer periphery (14) of the annular member (13) or the channel (28) can be configured to engage any cross-sectional configuration of the column (4). Accordingly, while FIGS. 2 and 3 represent a best mode of the spinner assembly (2) in the context of a column (4) circular in cross section, it does not preclude using the spinner assembly (2) shown in FIGS. 2 and 3 with a wide variety of figurines (3), columns (4) and bases (5) in various permutations and combinations or using other configurations of the bearing cup (16) or with other configurations of the bearing (19) in such combinations or permutations, even if the rotation of the figurine (3) achieved in such permutations or combinations has a greater or lesser resistance to forcible urging.

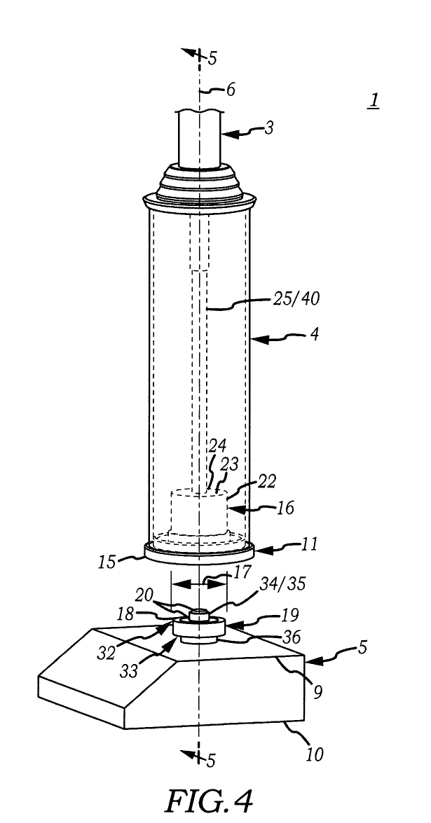

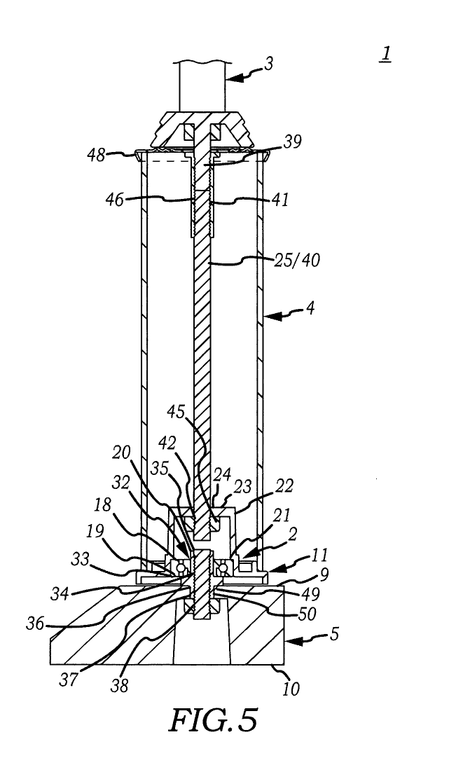

Now referring to FIGS. 4 and 5, which show a particular embodiment of the trophy (1) with the spinner assembly (2) as above described adapted for use between the column (4) and the base (5). In adapting the spinner assembly (2) above-described for use between the column (4) and the base (5), the column cover (11) coupled to the bearing cup (16) with the roller element bearing (19) axially slidably inserted into the bearing cup (16) to engage the annular step (21) can be fixedly or removably engaged to the column end proximate the base (5). The embodiment of the spinner assembly (2) shown in FIG. 5 provides a column securement element (29) located proximate the outer periphery (14) which includes only an inner ring (27) which insertably engages a corresponding part of the internal surface of the column (4). The bearing cup (16) further provides a closed end (23) which defines a securement aperture (24). A securement element (25) in the form a of a rod (40) having a spiral thread (41) (42) coupled to opposed ends (43) (44) passes through the securement aperture (24) and receives a correspondingly spirally threaded retainer element (45) (46) at each of the opposed ends (43) (44). The axial extending projection (39) of the figurine (3) passes through a column cap aperture (47) of a column cap (48) and can be received in the spirally threaded retainer element (46). Operation of the securement element (25) draws into fixed engagement the figurine (3) and the column cap (48) with the first end of the column (4) and the column cover (11) into engagement with the second end of the column (4). The spinner shaft (34) can be adapted to secure to the base (5) by including a base securement element (49) coupled to the second spinner shaft end (37) which slidely inserts into the base aperture (50). The base securement element (49) can be an axial extension of the spinner shaft (34) and hollow passage (38) which inserts into the base aperture (50) and receives a spirally threaded base fastener (51) which operates to draw the shaft cap (36) against the first base end (9). The first spinner shaft end (35) axially slidably inserts into the bearing aperture (20) to rotatably engage the column (4) in relation to the base (5). Forcible urging of the column (4) about the longitudinal axis (6) of the trophy (1) can result in rotation of the column (4) and the figurine (3) about the longitudinal axis (6) of the trophy (1).

As can be easily understood from the foregoing, the basic concepts of the present invention may be embodied in a variety of ways. The invention involves numerous and varied embodiments of a trophy system with spinner assembly.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “spinner” should be understood to encompass disclosure of the act of “spinning”—whether explicitly discussed or not—and, conversely, were there effectively disclosure of the act of “spinning”, such a disclosure should be understood to encompass disclosure of “a spinner” and even a “means for spinning.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

For the purposes of the present invention, ranges may be expressed herein as from “about” one particular value to “about” another particular value. When such a range is expressed, another embodiment includes from the one particular value to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Moreover, for the purposes of the present invention, the term “a” or “an” entity refers to one or more of that entity; for example, “a protein” or “an peptide” refers to one or more of those compounds or at least one compound. As such, the terms “a” or “an”, “one or more” and “at least one” can be used interchangeably herein. Furthermore, a compound “selected from the group consisting of” refers to one or more of the compounds in the list that follows, including combinations of two or more of the compounds. According to the present invention, an isolated or biologically pure bioactive agent is a compound that has been removed from its natural milieu. As such, “isolated” and “biologically pure” do not necessarily reflect the extent to which the compound has been purified. An isolated compound of the present invention can be obtained from its natural source, can be produced using molecular biology techniques or can be produced by chemical synthesis.

Thus, the applicant(s) should be understood to claim at least: i) a trophy system with spinner assembly as herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of producing a trophy, comprising the steps of:
a) providing a figurine;
b) providing a column having a first column end and a second column end;
c) coupling a spinner assembly between said figurine and said first column end to rotatably engage said figurine to said first column end;
d) fixedly coupling a base to said second column end.

2. A method of producing a trophy, comprising the steps of
a) providing a figurine;
b) providing a column having a first column end and a second column end;
c) fixedly coupling said figurine to said first column end;
d) providing a base;
e) coupling a spinner assembly between said second column end and said base to rotatably engage said column to said base.
